(19) United States
(12) Patent Application Publication
(10) Pub. No.: US 2003/0202924 A1
(43) Pub. Date: Oct. 30, 2003

(54) Autoclave waste gas recycle and oxygen addition system

(76) Inventors: Natarajan Narasimhan, Highland Park, NJ (US); Graeme Dunn, Guildford (GB)

Correspondence Address: Joshua L. Cohen, Intellectual Property Dept., The BOC Group, Inc., 100 Mountain Ave., Murray Hill, NJ, 07974, US

(21) Appl. No.: 10/132,491

(22) Filed: Apr. 25, 2002

(51) Int. Cl. B01D 11/00

(52) U.S. Cl. 423/150.1

(57) ABSTRACT

A system 10 is provided to recycle a waste gas stream 32 of an autoclave 20 to re-use oxygen in the waste gas stream 32 to compliment an oxygen feed stream 19 to the autoclave 20, thereby recycling the waste gas stream 31 to avoid the necessity of having to continuously purge the waste stream 32 of contaminants, while also reducing the amount of oxygen necessary in the feed stream 19 to the autoclave 20. The waste gas stream 32 is also pressurized to be substantially similar in pressure to that of the feed stream 19 to the autoclave 20.

### BACKGROUND OF THE INVENTION

1. Field of the Invention

The present invention relates to systems wherein a waste gas stream containing unused oxygen is recycled to an autoclave inlet to be mixed with oxygen input to meet the oxygen demand in the autoclave and in particular, to autoclave waste gas streams associated with nickel leaching processes.

2. Description of the Prior Art

In a nickel leaching process, such as that pertaining to acid leach or ammonia leach, oxygen is supplied in a pressurized gas stream to an autoclave. Only a portion of the oxygen contained in the stream is consumed (typically from about 40-60%), while the remainder of the oxygen is rejected or exhausted in an oxygen depleted exhaust gas stream. The exhaust stream also contains ammonia (and sometimes carbon dioxide) which must be recovered downstream before the gas is vented external to the process or into the environment.

Depending upon the nickel leaching process being used, the exhaust stream may be at an elevated pressure.

When air is supplied to an autoclave, a portion of the oxygen contained in the air is consumed by the autoclave. The oxygen depleted exhaust stream exits the autoclave to be passed to a scrubbing system where the ammonia in the system is recovered from the leach system.

The above systems therefore have the disadvantage that a considerable portion of the oxygen in the feed air to the autoclave is exhausted i.e., wasted during the process. In addition, the exhaust stream must be scrubbed of harmful products and chemicals before it is vented to the environment.

### SUMMARY AND OBJECTS OF THE INVENTION

The autoclave waste gas recycle system according to the present invention recompresses and recycles the waste gas stream (“waste stream”), for example, from a Nickel Leach Autoclave. The waste stream having an oxygen content is mixed with feed oxygen to meet the autoclave oxygen demand. The system of the present invention recirculates the oxygen remaining in the waste stream to be re-used and thereby reduce the amount of air or oxygen required to meet the oxygen demand at the feed for the autoclave.

In particular, there is provided a system for recycling a waste stream of an autoclave which includes an autoclave having an inlet for receiving a feed stream at a first pressure and with a first oxygen content, an outlet for exhausting a waste stream at a second pressure and with a second oxygen content less than the first oxygen content; and circulating means interconnecting the inlet and the outlet of the autoclave for circulating the waste stream to the inlet at a pressure greater than the second pressure for being mixed with the first oxygen content of the feed stream.

The present invention also provides a method of recycling oxygen for use in an autoclave and includes the steps of providing a feed stream with a first oxygen content to an autoclave; exhausting a waste stream with a second oxygen content from the autoclave; pressurizing the waste stream exhausted from the autoclave; circulating the pressurized waste stream to the feed stream; and mixing the pressurized waste stream with the feed stream for the second oxygen content to be combined with the first oxygen content.

The oxygen concentration in the feed gas stream to the autoclave can be adjusted, such as enriched, to meet the demand of the inventive process, and the recycling feature enables this to be done without additional oxygen loss.

The recycling of the autoclave waste stream substantially reduces the requirement for continuous downstream ammonia recovery thereby reducing operating costs and losses.

In the present invention, the waste stream exiting the autoclave is also recompressed or pressurized for delivery at the feed pressure, mixed with the feed oxygen to restore the concentration necessary for introduction at the feed inlet and delivered to the autoclave. Accordingly, the oxygen that would have been vented from the waste stream as an unused by-product is now re-used and consumed in the process of the present invention and thus, a reduced amount of oxygen (as air or pure oxygen) needs to be supplied at the autoclave inlet.

The amount of oxygen in the feed gas stream can be adjusted to a concentration best suited to the process conditions and to take into account the introduction of the additional oxygen that will be provided from the recycled waste stream.

The present invention can be applied to Oxide ore concentrates, hydroxide precipitates (all laterite mineral derived), as well as sulfide concentrates and mattes.

Objects and Advantages of the System of the Present Invention Include:

1. Improved oxygen utilization. Nearly complete oxygen utilization is achieved, thus reducing oxygen supply costs.

2. Reduced power consumption. For a high pressure leach system (e.g., one operating at 10 bar), there are significant savings in power consumption. The energy to recompress the waste stream from 7 bar at the autoclave exhaust to 10 bar at the autoclave feed inlet, combined with the energy to provide the make-up oxygen at 10 bar, is considerably less than that associated with a single pass air system.

3. Eliminate ammonia recovery/losses. The waste stream from the autoclave contains a significant amount of gaseous ammonia. This has to be recovered for economic and environmental reasons before the stream can be vented. Venting requires a scrubbing system to dissolve the ammonia in water and a stripping system to concentrate the ammonia solution for re-use. By recycling the waste stream, instead of immediately exhausting the waste stream from the system, these requirements are substantially reduced if not eliminated, giving both capital benefits and operational savings in the utilities required (steam and cooling water).

4. Eliminate carbon dioxide recovery losses. Where carbon dioxide is dissolved as part of the process, recycling the waste stream reduces the losses.

5. Ability to control oxygen concentration. This will increase the efficiency/throughput of the leach system by increasing the oxygen concentration above that of an air based system. Recycling of the waste stream provides for an economic option, since the present invention eliminates the oxygen losses that would otherwise have ensued from this approach.

### BRIEF DESCRIPTION OF THE DRAWINGS

For a more complete understanding of the present invention, reference may be had to the following detailed description taken in conjunction with the accompanying drawings, of which:

FIG. 1 is a diagram of a preferred embodiment of the waste gas recycle system according to the present invention; and

FIG. 2 is a diagram of another preferred embodiment of a feed stream for the system of FIG. 1.

### DETAILED DESCRIPTION OF THE PREFERRED EMBODIMENTS

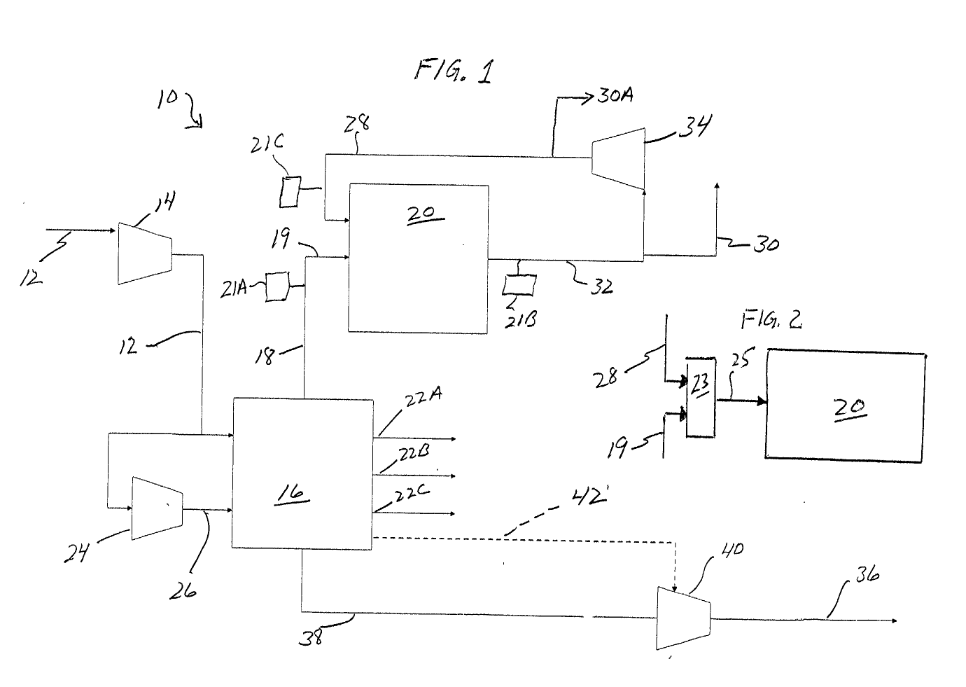

Referring to FIG. 1, there is shown an air based reactor, such as an autoclave, retrofitted to provide an oxygen based recycle system for the autoclave according to the present invention shown generally at 10.

Air 12 introduced to a process air compressor 14 is subsequently provided at an increased pressure to an air separation unit (ASU) 16. The compressor 14, instead of providing air to the autoclave, now provides air for the ASU 16.

The ASU 16 provides a first exhaust stream 18 containing oxygen at for example, 10 bar(g) to an autoclave 20, as well as secondary exhaust streams 22A-C of liquid products, for example liquid oxygen, liquid nitrogen, crude liquid argon, respectively, for the merchant market and gaseous nitrogen for other site users. The ASU 16 can be an “internal compression cycle” type.

Some of the air 12 provided by the process air compressor 14 can be further compressed in a booster air compressor 24 to provide a high pressure air stream 26 (25-60 bar) of which part is used to vaporize a pumped liquid oxygen stream to provide the 10 bar(g) oxygen (see 18 below), while a further portion is expanded to provide the refrigeration for liquid production as discussed hereinafter.

The first exhaust stream 18 becomes a feed stream 19 having oxygen from the exhaust stream 18. The feed stream 19 for the autoclave 20 is mixed with a recycled waste gas stream 28 to achieve a combined feed stream oxygen purity of around 21%. The mixing of streams 19, 28 preferably occurs external to the autoclave 20 at a pre-mixer apparatus 23 as shown in FIG. 2, so that a single feed stream 25 enters the autoclave 20. Alternatively, the streams 19, 28 can be introduced separately as in FIG. 1 for mixing within the autoclave 20. This mixing as would result from either of the embodiments of FIGS. 1 and 2 maintains the same operating conditions in the autoclave 20 as occurs with the original air fed operation. The recycled stream 28 has an oxygen content of about 10%, while the feed stream 19 has an oxygen purity of around 99.5%, with Argon being its main impurity. High purity oxygen is used to minimize the buildup of inerts in the system 10. A lower oxygen purity can be used, such as 95%, but this would result in a higher loss at a purge stream 30 or 30A of the system 10.

The combined streams (recycle waste 28 plus feed 19) are provided to the autoclave 20 as in either of FIGS. 1 or 2, where a significant portion of the contained oxygen is consumed in the autoclave 20. A waste gas stream 32 (“waste stream”) exits the autoclave 20 at about 7 bar(g) and is depleted in oxygen relative to the feed stream 19. A typical oxygen content of approximately 10% can be expected in the waste stream 32.

The waste stream 32 also contains significant quantities of ammonia, one of the reactants in the process. The ammonia would have to be removed in a scrubbing and recovery system if the waste stream 32 were to be vented to the atmosphere. Instead, the waste stream 32 is recompressed (pressurized) and recycled at a recompressor device 34 to 10 bar(g) to provide the waste stream 28 to the feed stream 19 of the process. In a preferred embodiment, the recompressor device 34 includes components constructed and arranged to provide an integral unit to both recirculate the waste stream 32 and pressurize the waste stream 32. Accordingly, both the unused oxygen and the ammonia in the waste stream 32 are recycled in the process.

The energy required to recompress the waste stream 32 and to provide the make-up or additional oxygen (i.e., enhance the oxygen introduced into the autoclave 20) is considerably less than that required to provide air only to the process. The costs of recovering the ammonia are also substantially reduced, if not eliminated.

Sensing means is also provided for the system 10. Sensor 21A is provided to be in communication with the streams 18 and 19, to thereby sense oxygen content and pressure of the streams 18, 19. Sensor 21B is in communication with the waste stream 32, to thereby sense oxygen content and pressure of the stream 32. Sensor 21C is in communication with the recycle waste stream 28 to thereby sense the oxygen content and pressure of the stream 28. Monitoring of the sensors 21A-C is to be aware of and control the oxygen content and pressure of the streams 18 and 19, 28 and 32 so that the stream 32 is properly pressurized at recompressor 34 for recycling the stream 28, depending upon the oxygen content sensed in the stream 32. Monitoring of the sensors 21A-C enables controlling of the streams 18 and 19, 28 and 32 and also determines when the stream 32 must be purged at 30.

In an alternative embodiment, the sensors 21A-C will also sense the flow rate of the respective streams 18 and 19, 32 and 28 to facilitate controlling the flow rate.

Continuous or batch purging of inerts or ammonia in the streams 28, 32 can be used.

The stream 30 is provided to purge the waste gas stream 32 of the accumulation of inerts in the process gas. The principal source of the inerts is the 0.5% Argon content in the feed stream 19. Purging of the waste stream 28 can also occur at purge steam 30A, which would not impact greatly the pressure or power demand to control the stream 28.

The process system 10 of the present invention can also, for example, provide specific requirements for the site in which the system is provided for operation. Referring to FIG. 1, if there is a demand for a high pressure nitrogen flow 36 for refrigeration for example, this demand can be met by compressing a low pressure nitrogen flow 38 from the ASU 16 which is providing the oxygen for the autoclave 20. The flow 38 is compressed at compressor 40 to provide the high pressure nitrogen flow 36. It is also possible to withdraw a portion of the nitrogen at the ASU 16 as a medium pressure nitrogen flow 42 at approximately 5 bar(g) and feed the medium pressure nitrogen flow 42 to the compressor 40 which permits a reduction in the power necessary at the compressor 40 to provide the high pressure flow 36.

Parameters of the features/elements of the present invention are provided below by way of example:

| | |
|---|---|
| 12 air | 38,675 nm 3/h |
| 14 process air compressor | 2950 kW |
| 18 first exhaust stream | 210 tons/day gaseous oxygen |
| 20 autoclave | 65% oxygen consumption |
| 22A liquid oxygen | 60 tons/day |
| 22B liquid nitrogen | 14 tons/day |
| 22C crude liquid argon | 3 tons/day |
| 24 booster air compressor | 1600 kW |
| 28 recycled waste gas stream | 33,300 nm3/h; 10% oxygen |
| 34 recompressor device | 540 kW |
| 36 high pressure nitrogen flow | 25 bar(g) |
| 38 low pressure nitrogen flow | 13,000 nm 3/h; 0.05 bar(g) |
| 40 compressor | 1830 kW |

It will be understood that the embodiments described herein are merely exemplary and that a person skilled in the art may make many variations and modifications without departing from the spirit and scope of the invention. All such modifications and variations are intended to be included within the scope of the invention as defined in the appended claims.

What is claimed is:

1. A system for recycling a waste stream of an autoclave, comprising:
an autoclave having an inlet for receiving a feed stream at a first pressure and with a first oxygen content, and an outlet for exhausting a waste stream at a second pressure and with a second oxygen content less than the first oxygen content; and
circulating means interconnecting the inlet and the outlet of the autoclave for circulating the waste stream to the inlet at a pressure greater than the second pressure for being mixed with the first oxygen content of the feed stream.

2. The system according to claim 1, further comprising:
purge means in communication with the waste stream for purging a portion of the waste stream from being circulated.

3. The system according to claim 2, wherein the purge means is in communication with the waste stream before the circulating means.

4. The system according to claim 2, wherein the purge means is in communication with the waste steam after the circulating means.

5. The system according to claim 1, wherein the circulating means comprises:
pressurizing means for increasing the second pressure of the waste stream to be substantially similar to the first pressure of the feed stream.

6. The system according to claim 1, further comprising: mixing means associated with the autoclave inlet, the mixing means constructed and arranged to receive the feed stream and the waste stream for mixing therewith and delivery to the autoclave.

7. The system according to claim 1, further comprising: sensing means in communication with at least one of the feed stream and the waste stream for sensing at least one of pressure, oxygen content and flow rate of said streams.

8. The system according to claim 1, wherein the feed stream and the waste stream are a gas.

9. The system according to claim 1, wherein the pressure of the waste stream is substantially equal to the first pressure of the feed stream.

10. A system for recycling oxygen used in an autoclave, comprising:
an inlet to the autoclave for a feed oxygen stream with a first oxygen content to be delivered to the autoclave;
an outlet from which a waste gas stream with a second oxygen content is exhausted from the autoclave; and
circulating means interconnecting the outlet and the inlet of the autoclave for circulating the waste gas stream from the outlet to the inlet, wherein the second oxygen content is mixed with the first oxygen content of the feed oxygen stream.

11. The system according to claim 10, further comprising: pressurizing means in communication with the waste gas stream for pressurizing the waste gas stream to a pressure similar to a pressure of the feed oxygen stream.

12. The system according to claim 11, wherein the pressurizing means and the circulating means are integrally constructed and arranged.

13. The system according to claim 10, further comprising:
purge means in communication with the waste gas stream for purging a portion of the waste gas stream from being circulated.

14. The system according to claim 13, wherein the purge means is in communication with the waste gas stream before the pressurizing means.

15. The system according to claim 13, wherein the purge means is in communication with the waste gas stream after the pressurizing means.

16. A method of recycling oxygen for use in an autoclave, the method comprising the steps of:
providing a feed stream with a first oxygen content to an autoclave;
exhausting a waste stream with a second oxygen content from the autoclave;
pressurizing the waste stream exhausted from the autoclave;
circulating the pressurized waste stream to the feed stream; and
mixing the pressurized waste stream with the feed stream for the second oxygen content to be combined with the first oxygen content for delivery to the autoclave.

17. The method according to claim 16, further comprising the step of:
purging the waste stream of inert components.

18. The method according to claim 17, wherein the step of purging the waste stream occurs before the step of pressurizing the waste stream.

19. The method according to claim 17, wherein the step of purging the waste stream occurs after the step of pressurizing the waste stream.

20. The method according to claim 16, wherein the step of mixing the pressurized waste stream with the feed stream occurs external to the autoclave.

21. A method of recycling oxygen used in an autoclave, comprising the steps of pressurizing and recycling a waste stream with oxygen from the autoclave for mixing with an oxygen feed stream to the autoclave.

22. The method according to claim 21, further comprising the step of:
purging a portion of the waste stream.

23. The method according to claim 21, further comprising the step of:
pressurizing the waste stream to a pressure substantially similar to a pressure of the oxygen feed stream.
